(19) United States
(12) Patent Application Publication
(10) Pub. No.: US 2011/0064499 A1
(43) Pub. Date: Mar. 17, 2011

(54) CLOSED LOOP STALLED ROLL REGISTRATION

(75) Inventors: Donald E. Johnston, Webster, NY (US); Joseph J. Ferrara, Webster, NY (US)

(73) Assignee: XEROX CORPORATION, Norwalk, CT (US)

(21) Appl. No.: 12/560,902

(22) Filed: Sep. 16, 2009

(51) Int. Cl. G03G 15/00; B65H 7/06; B65H 7/08; B65H 7/10

(52) U.S. Cl. 399/388; 271/228

(57) ABSTRACT

This invention uses a paper registration device with a paper transport and a stalled roll together with an upstream and downstream CIS to enable paper skew measurements. The upstream CIS is positioned on a paper sheet transport between a beginning pre-registration nip and a buckle control sensor. A second downstream CIS is aligned with the first upstream CIS to provide skew measurement on the same side of a paper sheet. An advantage of this registration device is that it simultaneously corrects registration in a process direction, a cross process direction and corrects skew angle.

This invention relates to a paper-handling system useful in an electrostatic marking process and, more specifically, to a novel sheet registration device.

### BACKGROUND

This invention includes use in any paper-handling system and the changing or correcting the orientation of the sheets traveling in a sheet transport path. In a marking system, sheets being fed to be marked or printed, sheets being fed for duplex printing, sheets being sent to a stacker and sheets outputted to a finishing station or other modules are all included within the scope of this invention. For clarity and understanding, the sheet registration system of this invention will be described herein in reference to pre-imaging paper feeding in an electrostatic marking systems both color and monochrome.

There have been related sheet registration systems used in the prior art, however, none of them combine effectiveness with acceptable associated costs. In U.S. Pat. No. 7,422,211 B2 (Dejong), a closed loop registration method is disclosed which improves on lateral registration and deskew systems such as that disclosed in U.S. Pat. No. 6,173,952. While effective, both processes involve relatively expensive components especially in high speed marking systems. Dejong's registration system does not use a stalled roll concept whereas use of a stalled roll is an essential part of the present invention.

U.S. Pat. Nos. 7,300,054; 7,303,191 and 7,319,842 issued to Canon disclose various sheet registration systems.

The registration device in color-marking systems has to be able to meet the requirements of Low, Mid and High Entry Production Color (EPC) market. In the Low and Mid EPC market, the machines typically use low cost stalled roll registration devices with front to back registration of 1 to 1.5 mm. The High EPC market requires front to back registration of 0.5 mm with slightly higher Unit Manufacturing Cost (UMC). This invention solves this problem by applying closed loop control of skew and cross process registration to a stalled roll device.

### SUMMARY

This invention builds on the Xerox color printer's registration module by adding closed loop control for skew correction in addition to the cross process correction. The Xerox registration device uses a stalled roll with a manual skew setup adjustment. Cross process correction is done with a Contact Image Sensor (CIS) and translating the stalled roll registration nip inboard to outboard. This invention closes the loop by adding a second CIS before the stalled roll nip to enable skew measurement and adding a stepper motor to the manual skew adjustment. Also, important to this invention is the combination of closed loop control with a stalled roll registration device. Both of these expedients are essential to the present invention. Proportional feedback from the two CIS devices is used to simultaneously translate and rotate the registration nip to correct cross process registration and skew. A significant advantage of this invention is skew correction done off of the same edge for side 1 and side 2. A stalled roll device deskews side 1 and side 2 with opposite edges of the sheet that can cause a mean skew shift between side 1 and side 2.

As noted earlier, this invention applies the closed loop concept similar to that described in U.S. Pat. No. 7,422,211 but with use of a stalled roll registration device. The stalled roll registration is important to the present invention. The Canon patents do not use stalled roll registration but use the translating and pivoting nip to correct skew and cross process registration. Also, the Canon patents describe open loop corrections without feedback to close the loop as is necessary in the present disclosure.

Stalled roll registration devices have not been known for meeting tight registration targets. The lowest cost stalled roll devices consist of a registration nip that is stopped while a sheet is driven into the nip. An open area upstream of the stalled roll nip allows the paper to buckle, driving the lead edge of the sheet evenly into the nip, deskewing it. The lead edge of the sheet is registered to the image by timing the start of the nip or executing a velocity profile based on the timing from a downstream sensor. Lowest cost stalled roll devices do not have cross process or skew adjustment. In a Xerox method, a motor is used to translate the nip in the cross process direction with a Contact Image Sensor (CIS) to measure the sheet location which is added to provide cross process adjustment. Skew is not adjusted on a sheet by sheet basis. In order to meet a registration target of 0.5 mm front to back, the skew for both sides has to be adjusted on a sheet by sheet basis and off the same edge. Skew is adjusted on opposite edges between the sides allowing the possibility of a mean skew shift. This shift of the skew mean can make it impossible to meet the tight registration specification. This invention builds on the Xerox registration device by adding a second CIS sensor to enable skew measurement and a stepper motor to pivot the registration device for skew adjustment. Closed loop control can be done with a simple proportional control algorithm. The cross process and skew error are measured by the CIS devices and multiplied by a constant to calculate a velocity target for the respective actuators. Logic is used to limit the acceleration of the stepper motors and control their velocities within their operating ranges. When the error falls below an error limit, the actuators are turned off. The error continues to be monitored and the actuators are turned on if the error rises back above the limit until the error returns back below the limit. This is important because skew is removed by tilting the nip which causes the sheet to translate as the sheet moves forward. Continuing the closed loop control until transfer compensates for this situation. The amount of translation is small because the stalled roll nip function reduces the incoming skew to small amounts, limiting the amount of registration nip angle. When the sheet is in transfer, the registration nip is opened eliminating transfer defects and allows the nip to return home for the next sheet.

An advantage of this invention is skew correction which is done off of the same edge for side 1 and side 2. A normal stalled roll device deskews side 1 and side 2 with opposite edges of the sheet that can cause a mean skew shift between side 1 and side 2. Other advantages are performing lateral skew and top edge stall-roll registration correction simultaneously, adding only one additional sensor and motor to the existing hardware configuration and no need for additional system processors. The system of this invention is easily retrofitted into existing marking apparatuses with a minimum cost involved.

Various sheet registration systems used in the prior art vary in price, some as high as about $4,000. It is estimated that the disclosed registration system of this invention will cost approximately up to $200. Thus, besides being an improved and easily retrofitted registration system, the present invention provides a cost effective improvement over the prior art systems. Various optical lead edge optical sensors used in this invention are well known in the prior art such as those disclosed in U.S. Pat. Nos. 5,678,159 and 5,697,608.

The present registration system provides skew correction of the sheet in the process direction, in the cross-process direction and in the sheet skew angle, all at substantially the same time. Stepper motors are used to effectuate each of the above corrections. Prior registration systems that used a stalled roll also used a manual skew setup adjustment. The present invention closes the loop by adding a second contact image sensor (CIS) before the stalled roll nip to enable skew measurement and adding a stepper motor to the previous manual skew adjustment. Also important to this invention is the combination of closed loop control with a stalled roll registration device. All of the sensors and motors used in the present invention are controlled by an appropriate controller. As noted earlier, a normal prior art stalled roll device deskews side 1 and side 2 with opposite edges of the sheet that can cause a mean skew shift between side 1 and side 2. A significant advantage of this invention is skew correction which is done off the same edge for side 1 and side 2. Final skew correction using an upstream CIS sensor and a downstream CIS sensor and a stepper motor to replace manual registration are essential elements of the present invention. Using a CIS sensor between the pre-registration nip and the buckle control sensor is also important to this invention. An important advantage to the present invention is that it takes out the major skew in a first step and the stalled roll actuators need not adjust or correct the major skew.

### BRIEF DESCRIPTION OF THE DRAWINGS

FIG. 1 is a schematic of a monochromatic electrophotographic marking system where the registration system of this invention can be used.

FIG. 2 illustrates a side view of the closed loop stalled roll paper path section of an embodiment of this invention.

FIGS. 3 and 4 illustrate a top view of the closed loop stalled roll paper path section of an embodiment of this invention as the paper progresses through de-skewing.

### DETAILED DISCUSSION OF DRAWINGS AND PREFERRED EMBODIMENTS

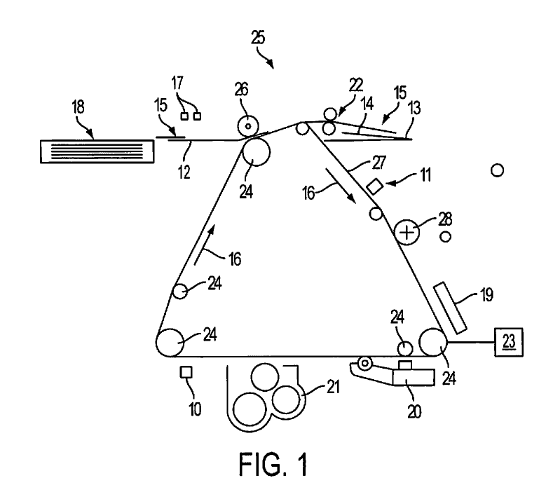

In FIG. 1, an electrophotographic marking apparatus 25 is illustrated to show where the registration system of the present invention is used. While, most likely, the registration system of this invention will be used in high speed color or more complex marking apparatus, FIG. 1 is shown for ease of understanding. As noted earlier, the registration system of this invention can be used in the paper feeder station 18. It can be used also when paper 15 is fed to a finishing station, duplexing or sheets fed to any other output module. In FIG. 1, the registration system of this invention is located on the path 12 where paper 15 is fed to transfer station 26. Sensors 17 used in the present registration system can be located along path 12. After the paper 15 leaves the transfer station 26, it is fed to fusing station 22 to a collection station 14 where the paper sheet 15 can be fed to a finisher for stacking assembly 13. Feeding sheets 15 to a finishing station can also use the registration system of this invention. Other sensors 10 and 11 can be used in the marking apparatus 25 for multiple purposes. Arrows 16 show the direction of the photoconductive belt 27. The charging station is shown at 19, exposure station at 20, developer station at 21, transfer station at 26 and cleaning station at 28. Rollers 24 move the belt 27 from power from motor 23.

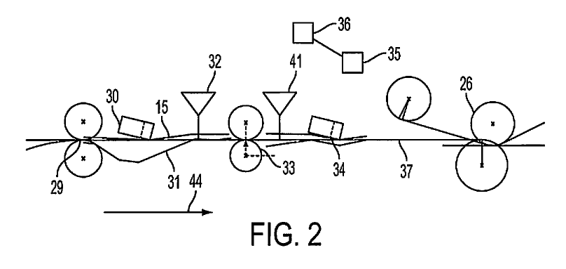

In FIG. 2, paper feed path 12 from FIG. 1 is shown with its specific components of the registration system of the present invention. A side view schematic is shown where paper 15 enters pre-registration nip 29 and is fed to below upstream contact image sensor (CIS) 30 which is above the buckle chamber 31, past buckle control sensor 32 before it passes to the stalled roll registration nip 33. The paper 15 travel direction is shown by arrow 44. It is critical to the invention that the CIS-30 sensor be positioned after the pre-registration nip 29 and before the stalled roll registration nip 33 to ensure enough distance from CIS-34 to enable accurate skew measurement. After the stalled roll registration nip 33 is positioned, a downstream CIS-34 which is horizontally aligned with upstream CIS-30 so that skew correction is done off the same edge for side A and side B of the paper sheet is shown. The sheet 15 position is measured for process direction, cross-process direction and skew angle at the same time. Stepper motor 42 connected to controller 36 adjust and correct the skew in sheet 15 to the proper alignment using input from sensors 30 and 34. The present registration system combines a closed loop control with a stalled roll registration device and a contact image sensor 34 located after the stalled roll 33. A second downstream contact image sensor 34 is horizontally aligned with sensor 30. These sensors 30 and 34 measure the skew and cross process position on the same side of the sheet, then via the controller 36 and motors 35 and 42 move the stalled roll nip 33 back and forth to correct the cross process position, and rotates the stalled roll nip 33 to correct skew in the sheet 15. The velocity of the stepper motors 35 are adjusted and move the registration of sheet 15 to correct for skew, process direction registration and cross-process direction registration at the same time. Paper transport 37 then moves the registered paper sheet 15 to the transfer station 26.

By “closed loop” is meant throughout this disclosure and claims a process that continuously measures and adjusts the lateral and skew position of sheets during transport in a marking apparatus and as “closed loop” is defined in U.S. Pat. No. 7,422,211 B2; which patent is incorporated by reference into the present disclosure. By “stalled roll” nip is meant a stationary nip that a sheet is driven against to square the lead edge of the sheet. By “cross process” correction is meant correcting the sheet position in the direction perpendicular to the paper travel direction, by “process direction is meant correcting the sheet position in the direction of sheet travel, by “skew” is meant correcting the angle of the sheet. As noted earlier, it is important to the present invention that simultaneous skew and cross process correction occur simultaneously because as the stalled roll nip is rotated to straighten the sheet angle the sheet will travel in the cross process direction and this requires continuous correction by controller 36 using stepper motor 35.

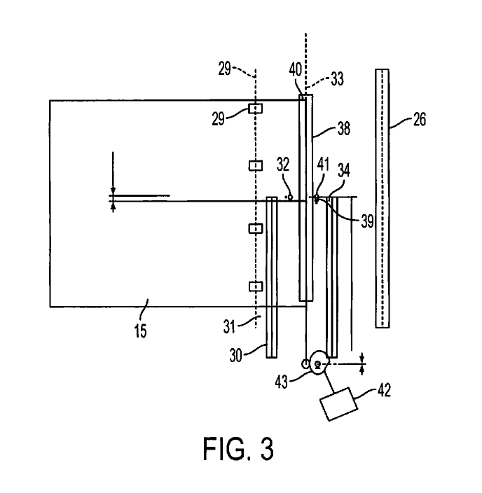

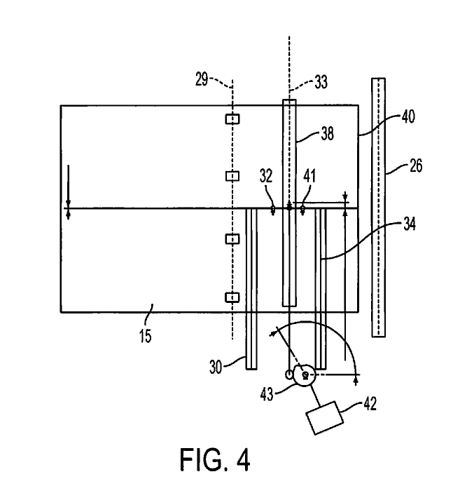

In FIGS. 3 and 4, a top partial view of the assembly of FIG. 2 is shown as paper sheet 15 enters the nip 33 in the stalled rollers 38. The buckle control sensor 32 is used to time the sheet velocity profile to control the buckle formed in the sheet 15 as its edge enters the stall roll registration nip 33 and the paper 15 buckles in the buckle chamber 31. Sheet 15 deceleration starts at this time. As a buckle is formed in the buckle chamber with the lead edge 40 of the sheet 15 against the stalled roll 38, the sheet begins to be deskewed. The stalled roll registration nip 33 accelerates and after the paper lead edge 40 passes the leading edge registration sensor 41, a velocity profile is executed to register the lead edge 40 and cross process correction can start based on error measurements at the upstream CIS sensor 30. When the lead edge 40 is past the second CIS 34, skew correction can begin by energizing the skew adjustment cam motor. Notice that cross process correction is being done simultaneously with skew correction until correction is complete as shown in FIG. 4. Initial cross process correction is completed and the nip tilted and skew correction is continuing.

All references cited in this disclosure and their references are incorporated by reference herein when appropriate for teachings of or details and features of the present invention.

In summary, the present invention provides a novel electrostatic marking apparatus and a novel paper registration device. The electrophotographic marking apparatus comprises a paper sheet feeding station and a closed loop paper registration device. This closed loop paper registration device comprises a controller, closed loop control and a stalled roll registration nip and a paper sheet transport with a beginning positioned pre-registration nip. This stalled roll registration nip is positioned on the paper sheet transport.

A first upstream contact image sensor (CIS) is positioned on the paper transport between the stalled roll registration nip and the pre-registration nip. A second downstream contact image sensor is positioned on the paper transport at a location after the stalled roll registration nip. The controller and a motor are in contact with both the first upstream and the second downstream CIS. The first upstream and the second downstream CIS are configured to continuously provide proportional feedback information on a skew of the paper sheet.

The controller which is in contact with the first upstream and the second downstream CIS sensors is configured to simultaneously translate and rotate a paper registration nip to correct cross process and skew registration and configured to thereby deskew at least one side of the paper sheet.

A buckle chamber and a buckle control sensor is positioned between the pre-registration nip and the stalled roll registration nip. The paper leading edge sensor is positioned between the stalled roll registration nip and the second downstream CIS. The stalled roll registration nip is configured to provide a buckle in the paper sheet as a leading edge of the paper sheet enters the stalled roll registration nip.

The first upstream CIS and the second downstream CIS are configured to measure two points on the paper sheet to determine paper skew. The paper registration device of this invention is configured to begin skew adjustment by energizing a skew adjustment cam motor after a lead edge of the paper sheet is past the second downstream CIS.

The paper registration device is configured to substantially simultaneously correct sheet skew in a process direction, in a cross-process direction and correct skew angle.

The first upstream CIS is positioned between the pre-registration nip and a buckle control sensor. The first upstream CIS and the second downstream CIS are both configured to measure a paper skew from a same side edge of the paper sheet.

The paper registration device of this invention comprises a paper sheet transport with a beginning positioned pre-registration nip, a closed loop control and a stalled roll. The stalled roll registration nip is positioned on the paper sheet transport. Also on the transport is a first upstream contact image sensor (CIS) positioned on the paper transport at a point before the stalled roll registration nip. A second downstream contact image sensor (CIS) is positioned on the paper transport at a location after the stalled roll registration nip. The first upstream CIS and the second downstream CIS are positioned in substantial horizontal alignment with each other and are configured to provide proportional feedback information on a skew of the paper sheet. The controller is in contact with the CIS sensors and is configured to substantially simultaneously translate and rotate a paper registration nip to correct cross process skew adjustment and configured to thereby deskew at least one side of the paper sheet.

It will be appreciated that variations of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An electrophotographic marking apparatus comprising a paper sheet feeding station, said feeding station comprising a closed loop paper registration device, said closed loop paper registration device comprising:
a controller, closed loop control, and a stalled roll registration nip,
a paper sheet transport with a beginning positioned pre-registration nip,
said stalled roll registration nip on said paper sheet transport,
a first upstream contact image sensor (CIS) positioned on said paper transport before said stalled roll registration nip, and said pre-registration nip,
a second downstream contact image sensor position on said paper transport at a location after said stalled roll registration nip,
said controller and a motor in contact with both said first upstream and said second downstream CIS,
said first upstream and said second downstream CIS configured to continuously provide proportional feedback information on a skew of said paper sheet,
said controller in contact with said CIS sensors configured to simultaneously translate and rotate a paper registration nip to correct cross process skew adjustment and registration, and configured to thereby deskew at least one side of said paper sheet.

2. The marking apparatus of claim 1 wherein a buckle chamber and a buckle control sensor is positioned between said pre-registration nip and said stalled roll registration nip.

3. The marking apparatus of claim 1 wherein a paper leading edge sensor is positioned between said stalled roll registration nip and said second downstream CIS.

4. The marking apparatus of claim 1 wherein said stalled roll registration nip is configured to provide a buckle in said paper sheet as a leading edge of said paper sheet enters said stalled roll registration nip.

5. The marking apparatus of claim 1 wherein said first upstream CIS and said second downstream CIS are configured to measure two points on said paper sheet to determine paper skew.

6. The marking apparatus of claim 1 wherein said paper registration device is configured to begin skew adjustment by energizing a skew adjustment cam motor after a lead edge of said paper sheet is past said second downstream CIS.

7. The marking apparatus of claim 1 wherein said paper registration device is configured to substantially simultaneously correct sheet skew in a process direction, in a cross-process direction, and correct skew angle.

8. The marking apparatus of claim 1 wherein said first upstream CIS is positioned between said pre-registration nip and a buckle control sensor.

9. The marking apparatus of claim 1 wherein said first upstream CIS and said second downstream CIS are both configured to measure a paper skew from a same side edge of said paper sheet.

10. A paper registration device comprising:
a paper sheet transport with a beginning positioned pre-registration nip, a closed loop control and a stalled roll, said stalled roll registration nip on said paper sheet transport,
a first upstream contact image sensor (CIS) positioned on said paper transport at a point before said stalled roll registration nip,
a second downstream contact image sensor (CIS) positioned on said paper transport at a location after said stalled roll registration nip,
said first upstream CIS and said second downstream CIS positioned in substantial horizontal alignment with each other, and configured to provide proportional feedback information on a skew of said paper sheet,
said controller in contact with said CIS sensors and configured to substantially simultaneously translate and rotate a paper registration nip to correct cross process skew adjustment and configured to thereby deskew at least one side of said paper sheet.

11. The paper registration device of claim 10 wherein a buckle chamber and a buckle control sensor is positioned between said pre-registration nip and said stalled roll registration nip.

12. The paper registration device of claim 10 wherein a paper leading edge sensor is positioned between said stalled roll registration nip and said second downstream CIS.

13. The paper registration device of claim 10 wherein said stalled roll registration nip is configured to provide a buckle in said paper sheet as a leading edge of said paper sheet enters said stalled roll registration nip.

14. The paper registration device of claim 10 wherein said first upstream CIS and said second downstream CIS are configured to measure two points on said paper sheet to determine paper skew.

15. The paper registration device of claim 10 wherein said paper registration device is configured to begin skew adjustment by energizing a skew adjustment cam motor after a lead edge of said paper sheet is past said second downstream CIS.

16. The paper registration device of claim 10 wherein said paper registration device is configured to substantially simultaneously correct sheet skew in a process direction, in a cross-process direction, and correct skew angle.

17. The paper registration device of claim 10 wherein said first upstream CIS is positioned between said pre-registration nip and a buckle control sensor.

18. The paper registration device of claim 10 wherein said first upstream CIS and said second downstream CIS are both configured to measure a paper skew from a same side edge of said paper sheet.
